(19) United States
(12) Patent Application Publication
(10) Pub. No.: US 2014/0313898 A1
(43) Pub. Date: Oct. 23, 2014

(54) METHOD FOR DELIVERING EMERGENCY TRAFFIC IN SOFTWARE DEFINED NETWORKING NETWORKS AND APPARATUS FOR PERFORMING THE SAME

(71) Applicant: Electronics and Telecommunications Research Institute, Daejeon (KR)

(72) Inventors: Byung Ho YAE, Daejeon (KR); Nam Seok KO, Daejeon (KR); Sung Kee NOH, Daejeon (KR); Sung Jin MOON, Daejeon (KR); Jong Dae PARK, Daejeon (KR); Woo Sug JUNG, Daejeon (KR); Tae Soo CHUNG, Daejeon (KR); Hwan Jo HEO, Daejeon (KR)

(73) Assignee: Electronics and Telecommunications Research Institute, Daejeon (KR)

(21) Appl. No.: 14/256,848

(22) Filed: Apr. 18, 2014

(30) Foreign Application Priority Data
Apr. 18, 2013 (KR) 10-2013-0042672

(51) Int. Cl. H04L 12/851

(52) U.S. Cl. CPC H04L 47/2441; H04L 47/2408
USPC 370/236

(57) ABSTRACT

Disclosed are a method for delivering emergency traffic in a SDN based network and an apparatus performing the same. A method for delivering emergency traffic, performed in a controller, may comprise generating an emergency code for delivering the emergency traffic when an emergency state corresponding to a predefined type occurs; transmitting the emergency code to a first OpenFlow switch connected to a transmitting terminal transmitting the emergency traffic; and transmitting a message directing an update of the emergency code to at least one OpenFlow switch included in a forwarding path of the emergency traffic. Therefore, when an emergency state occurs in a network, emergency traffic corresponding to the emergency state may be delivered efficiently, and stabilities of network management and service qualities may be guaranteed accordingly.

### CLAIM FOR PRIORITY

This application claims priorities to Korean Patent Application No. 10-2013-0042672 filed on Apr. 18, 2013 in the Korean Intellectual Property Office (KIPO), the entire contents of which are hereby incorporated by references.

### BACKGROUND

1. Technical Field

Example embodiments of the present invention relate to a technique for controlling network traffic, and more specifically to a method for processing emergency traffic which can be applied to delivery of emergency traffic generated in a network based on software defined networking, and an apparatus for the same.

2. Related Art

Since a current network based on conventional routers and switches is configured with complex protocols and functions and there are various different operation manners and user interfaces for each of network apparatuses, it is very difficult for network operators or developers to develop and apply new network protocols, expand the network, or make network apparatuses interwork with each other.

In order to overcome the above-described problems, a technology of switches and routers having open-type interfaces has been studied. However, the networking technologies providing such the open-type interfaces has high price compared to performance, and so there have been difficulties in commercializing the technologies.

An ‘OpenFlow’ technology is a technology to overcome such the high cost problem and to provide users and developers with open-type standardized interfaces.

The OpenFlow technology separates functions of network switches (or, routers) into a packet forwarding function and a control function and provides a protocol for communications between two functions. This can enable determination of packet path in the switch by software executed in an external controlling apparatus independently to manufacturers of network apparatuses. The separation of the packet forwarding domain and the control domain makes further detail management of traffic possible as compared to an access control lists (ACL) or routing protocols which have been used in conventional network apparatuses.

The OpenFlow supports easy programming of flow tables in heterogeneous switches and routers based on the open-type protocol independently to types or manufacturers of network apparatuses. Also, by doing so, it can provide a new routing protocol, a security model, an addressing method, and a new internet technology development environment which can substitute Internet Protocol (IP).

The OpenFlow system includes at least one OpenFlow switch and at least one controller, and the switches and the controller may be connected to each other through an OpenFlow protocol.

The OpenFlow switch may include a flow table and communicate with the controller through a secured channel such as Secure Sockets Layer (SSL). In order to process received packets, the flow table may include packet header information (rule) defining a flow, action information indicating how to process a packet, and statistical information for each flow. The secured channel is a communication channel between the switch and the controller located in a remote position, and important information for controlling the OpenFlow switch is exchanged through the secured channel. The information exchanged through the secured channel is transmitted as encrypted.

The controller may make a flow table in the OpenFlow switch according to the OpenFlow protocol, and perform a function of registering a new flow in the flow table or a function of deleting a flow in the flow table.

An ‘Open Networking Foundation (ONF)’ defined a technology of Software Defined Networking (Hereinafter, referred to as ‘SDN’) which can program a network more easily based on the OpenFlow in addition to the openness provided by the OpenFlow technology.

The SDN is pursuing a purpose of developing software-oriented network technologies based on the OpenFlow. The ONF defines a networking system as a functional model similar to a computer system comprising hardware, an Operating System (OS), and application programs and defines the OpenFlow as an interface connecting hardware (for example, switches) and network operating systems.

Therefore, the SDN provides a development environment which can make network users not subordinate to hardware types and develop various application programs. Accordingly, it is expected that the SDN will provide a foundation of new networking technologies including new internet technologies.

Meanwhile, in the conventional OpenFlow technology, the controller and the OpenFlow switch performed processes on inputted packets based on the flow table. That is, since forwarding of all the packets through the OpenFlow switch is determined according to information of a transmitting terminal defined in the flow table, there is not a method for controlling traffic in the network promptly and guaranteeing flow of emergency traffic when an emergency state occurs. Also, there is not a method for preventing a user from modifying packet header information maliciously.

### SUMMARY

Accordingly, example embodiments of the present invention are provided to substantially obviate one or more problems due to limitations and disadvantages of the related art.

Example embodiments of the present invention provide a method for delivering emergency traffic which can deliver the emergency traffic efficiently in a SDN based network.

Example embodiments of the present invention also provide a communication apparatus perform a method for delivering emergency traffic in the SDN based network.

In some example embodiments, a method for delivering emergency traffic, performed in a controller, may comprise generating an emergency code for delivering the emergency traffic when an emergency state corresponding to a predefined type occurs; transmitting the emergency code to a first OpenFlow switch connected to a transmitting terminal transmitting the emergency traffic; and transmitting a message directing an update of the emergency code m to at least one OpenFlow switch included in a forwarding path of the emergency traffic.

Here, the method may further comprise transmitting information indicating that the emergency state occurred to the at least one OpenFlow switch included in the forwarding path of the emergency traffic when the emergency state occurred.

Also, the information may include information about a flow in which the emergency state occurred.

Here, the generating an emergency code for delivering the emergency traffic may include configuring an emergency state class corresponding to the emergency state which occurred in a flow table of each of the at least one OpenFlow switch included in the forwarding path of the emergency traffic.

Also, the flow table may include an emergency state class field in which the emergency state class is recorded.

Here, in the transmitting a message directing an update of the emergency code, the message may include information about the emergency code.

In another example embodiments, a method for delivering emergency traffic, performed in an OpenFlow switch, may comprise receiving an emergency code from an OpenFlow controller; checking whether a packet received from a transmitting terminal is a packet corresponding to an emergency flow or not; and when the received packet is a packet corresponding to an emergency flow, recording the emergency code in a header of the received packet and transmitting the received packet.

Here, the method may further comprise receiving information indicating that an emergency state occurred from the controller prior to the receiving an emergency code.

Here, the receiving an emergency code may include recording the received emergency code in an emergency code field of a flow table.

Also, the checking whether a packet received from a transmitting terminal is a packet corresponding to an emergency flow or not may be performed by checking whether information included in the header of the received packet with flow information, in which emergency codes are recorded, of the flow table.

Here, in the recording the emergency code in a header of the received packet and transmitting the received packet, the emergency code may be recorded in an emergency code field in an extension header region of the header of the received packet, and the received packet may be transmitted when the received packet corresponds to an emergency flow, and the received packet may be discarded when the received packet does not correspond to an emergency flow.

In other example embodiments, an OpenFlow controller may comprise a controlling part configured to generate an emergency code for delivering emergency traffic when an emergency state corresponding to a predefined type occurs, transmit the generated emergency code to a first OpenFlow switch connected to a transmitting terminal, and transmit a message directing an update of the emergency code to at least one OpenFlow switch included in a forwarding path of the emergency traffic; and a communication part communicating with the first OpenFlow switch and the at least one OpenFlow switch according to control of the controlling part.

Here, the controlling part may transmit information indicating that the emergency state occurred to the first OpenFlow switch and the at least one OpenFlow switch when the emergency state occurred.

Also, the controlling part may transmit information about a flow in which the emergency state occurred as included in the information indicating that the emergency state occurred when the emergency state occurred.

Here, the controller may further comprise a storing part storing data, wherein the controlling part may record an emergency state class corresponding to the emergency state which occurred in an emergency state class field of a flow table of each of the first OpenFlow switch and the at least one OpenFlow switch, and may store the flow table in the storing part.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a network environment, to which a method for delivering emergency traffic according to an example embodiment of the present invention is applied, and an example of configuring a network based on SDN;

FIG. 2 is a view illustrating a configuration of a flow table managed by an OpenFlow controller in a method for delivering emergency traffic according to an example embodiment of the present invention;

FIG. 3 is a view illustrating a configuration of a flow table of an OpenFlow switch according to an example embodiment of the present invention;

FIG. 4 is a view illustrating a structure of an IPv6 packet used in a method for delivering emergency traffic according to an example embodiment of the present invention;

FIG. 5 is a flow chart illustrating a method for delivering emergency traffic according to an example embodiment of the present invention;

FIG. 6A is a block diagram illustrating a configuration of an OpenFlow controller performing a method for delivering emergency traffic according to an example embodiment of the present invention; and

FIG. 6B is a block diagram illustrating a configuration of an OpenFlow switch performing a method for delivering emergency traffic according to an example embodiment of the present invention.

### DESCRIPTION OF EXAMPLE EMBODIMENTS

Example embodiments of the present invention are disclosed herein. However, m specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

Hereinafter, a term ‘emergency state’ used in the following descriptions may mean a state in which a situation of a type predefined as an emergency situation occurs. Also, a term ‘emergency traffic’ or a term ‘emergency packet’ may mean traffic or a packet which is transmitted when the emergency state occurs. Also, a term ‘emergency flow’ may be used as a term defining a flow in which the emergency state occurs among a plurality of flows included in a flow table.

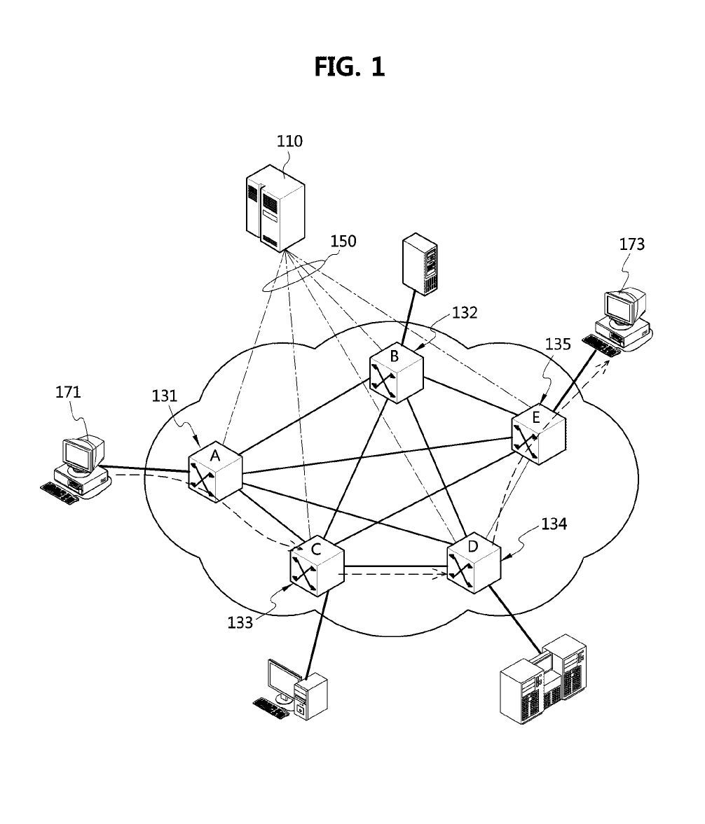

FIG. 1 is a conceptual diagram illustrating a network environment, to which a method for delivering emergency traffic according to an example embodiment of the present invention is applied, and an example of configuring a network based on SDN.

Referring to FIG. 1, the method for delivering emergency traffic according to an example embodiment of the present invention may be applied to a SDN network comprising an OpenFlow controller 110 and a plurality of OpenFlow switches 131 to 135.

The OpenFlow controller 110 may be connected to a plurality of OpenFlow switches 131 to 135, and may control traffic flows in the SDN network by communicating with the plurality of OpenFlow switches 131 to 135 through OpenFlow protocol 150.

The OpenFlow controller 110 may make respective flow table for each of the plurality of OpenFlow switches 131 to 135, configure packet forwarding paths in the SDN network from a transmitting terminal 171 to a receiving terminal 173, and deliver information about the configured path to OpenFlow switches located in the packet forwarding path.

In addition, the OpenFlow controller 110 may monitor whether an emergency state occurs or not, and perform controls for delivering emergency traffic (or, an emergency packet) when the emergency state occurs. Here, the ‘emergency state’ may mean a state in which a situation of a type predefined as an emergency situation occurs, and the ‘emergency traffic (or, emergency packet) may mean traffic or a packet which is transmitted in the SDN network according to the emergency state which occurred.

Each of the OpenFlow switches 131 to 135 may perform a function of communication node, configure a flow table based on information provided from the OpenFlow controller 110, discriminate received packets for each flow, and process the received packets according to a rule defined in the flow table. Here, the flow may be defined as packets having the same transmission control protocol (TCP) connection, the same Medium Access Control (MAC) address, the same IP address, or the same Virtual Local Area Network (VLAN) value.

For example, each of the OpenFlow switches 131 to 135 may deliver a received packet to a port defined in the flow table, or deliver the packet to a flow table controller 110 located in the external through a secured channel. That is, when the received packet is a first packet belonging to a new flow which is not registered in the flow table, the OpenFlow switch may deliver the received packet to the OpenFlow controller 110 and make the controller 110 determine whether the flow corresponding to the packet is to be registered in the flow table or not. Or, each of the OpenFlow switches 131 to 135 may drop the received packet for a special purpose. For example, each of the OpenFlow switches 131 to 135 may drop packets which are not emergency packets when it receives information indicating that emergency traffic occurs from the OpenFlow controller 110.

On the other hand, each of the OpenFlow switches 131 to 135 may be configured not to support conventional layer 2 functions and layer 3 functions, configured as an OpenFlow-dedicated switch only to support the OpenFlow protocol. Or, each of the OpenFlow switches 131 to 135 may be configured as a general purpose OpenFlow switch, a conventional switch to which a function of handling the OpenFlow protocol is added.

Since a packet forwarding path is determined based on a routing protocol in the conventional network, it is difficult that a packet is delivered through a path which a user desires. However, in the SDN based network depicted in FIG. 1, a single OpenFlow controller 110 may configure a packet forwarding path arbitrarily by controlling the plurality of OpenFlow switches 131 to 135 in a centralized manner.

For example, when a packet transmitted from the transmitting terminal 171 is delivered to the receiving terminal 173 through an OpenFlow switch 131, an OpenFlow switch 133, an OpenFlow switch 134, and an OpenFlow switch 135, the OpenFlow controller 110 may transmit path information to the OpenFlow switches 131, 133, 134, and 135 located in the packet forwarding path in advance, and each of the OpenFlow switches 131, 133, 134, and 135 may receive the path information from the controller 110, configure each flow table based on the received path information, and perform forwarding of the received packet to a next node (that is, a next OpenFlow switch) in the packet forwarding path so that the packet is transmitted from the transmitting terminal 171 to the receiving terminal 173.

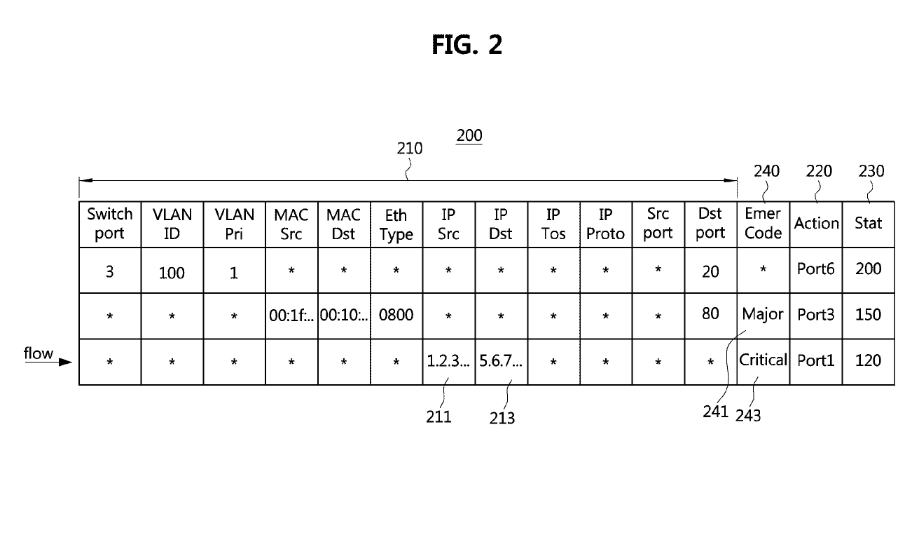

FIG. 2 is a view illustrating a configuration of a flow table managed by an OpenFlow controller in a method for delivering emergency traffic according to an example embodiment of the present invention. In FIG. 2, an example of a flow table for the OpenFlow switch 131 depicted in FIG. 1 is illustrated. The OpenFlow controller 110 may manage flow tables for each of other OpenFlow switches 132 to 135 as shown in FIG. 2.

Referring to FIG. 1 and FIG. 2, the OpenFlow controller 110 according to an example embodiment of the present invention may manage a flow table for each of the OpenFlow switches in order to deliver general traffic and emergency traffic. In a flow table 200 depicted in FIG. 2, each row may mean a flow.

The flow table 200 may comprise four key information.

That is, the flow table 200 may include packet header information (Rule) 210 defining flows, operation information (Action) 220 indicating how to process packets, statistical information (Statistic) 230 for each flow, and emergency state class information (Emergency Code) 240.

Here, the packet header information 210, the operation information 220, and the statistical information 230 are information defined in the SDN standard specification of the ONF, and the emergency state class information 240 is newly added information for delivering emergency traffic according to the present invention.

The packet header information 210 may include information such as a switch port, VLAN identification information (VLAN ID), VLAN priority information (VAL Pri), a MAC address of a transmitting terminal (MAC Src), a MAC address of a receiving terminal (MAC Dst), an Ethernet type (Eth Type), an IP address of a transmitting terminal (IP Src), an IP address of a receiving terminal (IP Dst), an IP service type (IP Tos), an IP protocol (IP Proto), a source port (Src Port), a destination port (Dst Port), etc.

The operation information 220 may include information indicating a method of processing packets, for example, information indicating that a packet is to be forwarded to a specific port, a packet is to be capsulized and forwarded to the OpenFlow controller 110, or a packet is to be discarded.

The statistical information 230 may include statistical information for each flow. Here, the flow may mean packets having the same TCP connection, the same MAC or IP address, or the same VLAN identifier.

The emergency state class information 240 is newly-added information for the method of delivering emergency traffic according to an example embodiment of the present invention, and is used for defining an emergency state for each flow.

The class for emergency state for each flow may be configured with three classes, for example, a minor class, a major class, and a critical class according to a priority of delivering traffic. The highest class is configured as the critical class, and the lowest class is configured as the minor class. However, the classification for emergency state is not limited the above described three classes. According to necessity, emergency state classes may be configured with more than three classes so that traffic delivery can be controlled in further detail.

Also, if a specific emergency state class is configured for a flow, a method for delivering emergency traffic according to an example embodiment of the present invention may be automatically applied to a flow having higher class than the configured class. For example, if a class of a specific flow is configured as a major class 241, a method for delivering emergency traffic may be applied to a flow configured as a critical class 243, a higher class than the major class 241.

In FIG. 2, a flow table 200, for delivering a packet transmitted from an address 211 of the transmitting terminal 171 connected to the OpenFlow switch A 131 to an address 213 of the receiving terminal 173, is illustrated. An example, in which an emergency state class is configured as a critical class 243, is illustrated.

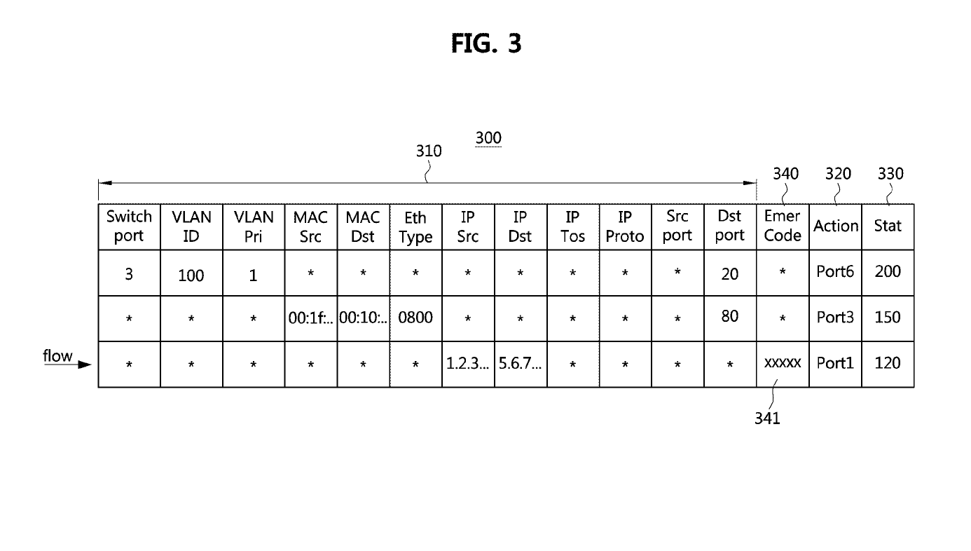

FIG. 3 is a view illustrating a configuration of a flow table of an OpenFlow switch according to an example embodiment of the present invention. That is, FIG.3 illustrates an example of a flow table 300 of the OpenFlow switch 131 in FIG. 1. Each row of the flow table 300 depicted in FIG. 3 may mean a flow.

Although FIG. 3 illustrates a flow table 300 of the OpenFlow switch 131 depicted in FIG. 1 as an example, other OpenFlow switches 132 to 135 may have flow tables having a form similar to the flow table 300.

Referring to FIG. 3, a flow table 300 according to an example embodiment of the present invention may include packet header information (Rule) 310 defining each flow, operation information (Action) 320 indicating how to process packets, statistical information (Statistic) 330 for each flow, and emergency state class information (Emergency Code) 340.

Here, the packet header information 310, the operation information 320, and the statistical information 330 are information defined in the SDN standard specification of the ONF, and the emergency state class information 340 is newly added information for delivering emergency traffic according to the present invention.

The packet header information 310 may include information such as a switch port, VLAN identification information (VLAN ID), VLAN priority information (VAL Pri), a MAC address of a transmitting terminal (MAC Src), a MAC address of a receiving terminal (MAC Dst), an Ethernet type (Eth Type), an IP address of a transmitting terminal (IP Src), an IP address of a receiving terminal (IP Dst), an IP service type (IP Tos), an IP protocol (IP Proto), a source port (Src Port), a destination port (Dst Port), etc.

The operation information 320 may include information indicating a method of processing packets, for example, information indicating that a packet is to be forwarded to a specific port, a packet is to be capsulized and forwarded to the OpenFlow controller 110, or a packet is to be discarded.

The statistical information 330 may include statistical information for each flow. Here, the flow may mean packets having the same TCP connection, the same MAC or IP address, or the same VLAN identifier.

The emergency state class information 340 is newly-added information for the method of delivering emergency traffic according to an example embodiment of the present invention, and is used for defining emergency states for each flow.

The emergency code may be generated by the OpenFlow controller 110, and delivered to each of the OpenFlow switches 131 to 135. Each of the OpenFlow switches 131 to 135 may record the emergency code delivered from the OpenFlow controller 110 in the flow table 300.

Then, each of the OpenFlow switches 131 to 135 may determine whether a received packet corresponds to an emergency flow (that is, a flow in which an emergency code is recorded) or not by referring to the emergency code recorded in the flow table 300. When the received packet corresponds to an emergency flow, the OpenFlow switch may deliver the received packet to a next OpenFlow switch. On the contrary, when the received packet does not correspond to an emergency flow, the OpenFlow switch may discard the received packet. Here, each OpenFlow switch may determine whether the received packet is a packet corresponding to an emergency flow or not by comparing a transmitting terminal address, a receiving terminal address, an emergency code, etc. included in a header of the received packet with contents of its flow table 300.

On the other hand, when an OpenFlow switch corresponds to the OpenFlow switch 131 depicted in FIG. 1 (that is, when an OpenFlow switch is connected to a transmitting terminal), if the OpenFlow switch 131 receives a packet corresponding to an emergency flow, it may record an emergency code recorded in the flow table 300 in an IPv6 extension header of the received packet, and deliver the packet in which the emergency code is recorded to a next OpenFlow switch.

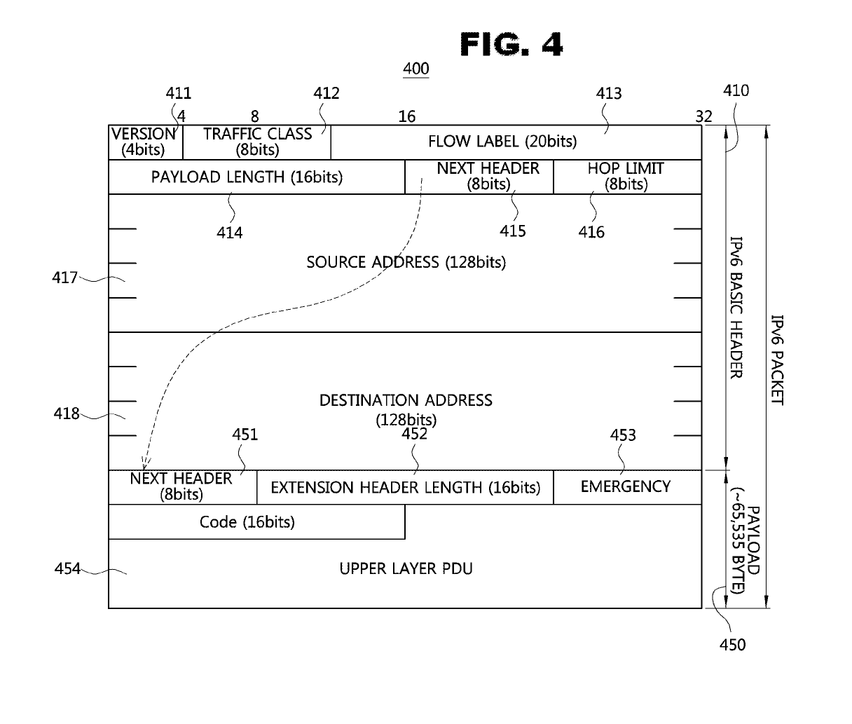

FIG. 4 is a view illustrating a structure of an IPv6 packet used in a method for delivering emergency traffic according to an example embodiment of the present invention.

Referring to FIG. 4, a structure of an IPv6 packet 400 according to an example embodiment of the present invention may be configured to comprise an IPv6 basic header 410 and a payload 450.

The IPv6 basic header 410 may include a version field 411, a traffic class field 412, a flow label field 413, a payload length field 414, a next header field 415, a hop limit field 416, a sender address field 417, and a destination address field 418.

The version field 411 is a field indicating an IP version, may be configured with 4 bits. For IPv6, the version field 411 has a value of 6.

The traffic class field 412 is a field indicating a class or a priority of an IPv6 packet, and may be configured with 8 bits. The traffic class field has a function similar to that of a Type of Service (ToS) field of an IPv4 packet. When interworking with IPv4, a value of the traffic class field is matched to a value of an IPv4 packet ToS field.

The flow label field 413 is a field including information identifying a flow of the packet, and may be configured with 20 bits.

The payload length field 414 is a field indicating a total length of a payload, and may be configured with 16 bits. Accordingly, a maximum length of the payload may be 65535 bytes. If a packet has a payload with more than 65535 bytes, a jumbo payload extension header option may be used.

The next header field 415 is a field indicating a type of an extension header located next to the basic header, and may be configured with 8 bits. The next header field may indicate a type of various extension headers according to a preconfigured value. In the present invention, the next header field may be used to indicate that the extension header includes emergency state information.

The hop limit field 416 is a field having a function identical to that of a Time-To-Live (TTL) field of an IPv4 packet, and may be configured with 8 bits. Every time when a packet is passed through a router, a value of this field decreases by 1, and the packet is discarded when the value of this filed becomes 0.

Each of the sender address field 417 and the destination address field 418 may be configured with 128 bits, and each of them may mean an address of a packet transmitting apparatus or a packet receiving apparatus which the packet is finally transmitted to.

The extension header is located next to the basic header 410, and may include a next header field 451, a header extension length field 452, and an emergency code field 453.

The next header field 415 may be configured with 8 bits, and used for indicating that emergency state information is included in the extension header.

The header extension length field 452 is a field indicating a length of the extension header, and may be configured with 16 bits.

The emergency code field 453 is a field for the method of delivering emergency traffic according to an example embodiment of the present invention, and may be configured with 16 bits. An emergency code generated by the OpenFlow controller 110 may be recorded in the emergency code field. Here, the emergency code may be generated as a random value within the given 16 bits, or generated as a value predefined according to an emergency state class.

The payload 454 may include the extension header and a protocol data unit (PDU) of a higher layer, and may have a size of maximum 65535 bytes.

Although an example in which the emergency code is configured with 16 bits is illustrated in FIG. 4, this illustrates only one example of the emergency code. That is, the emergency code may be configured with more bits than 16 bits, and the total size of the extension header may be increased for this.

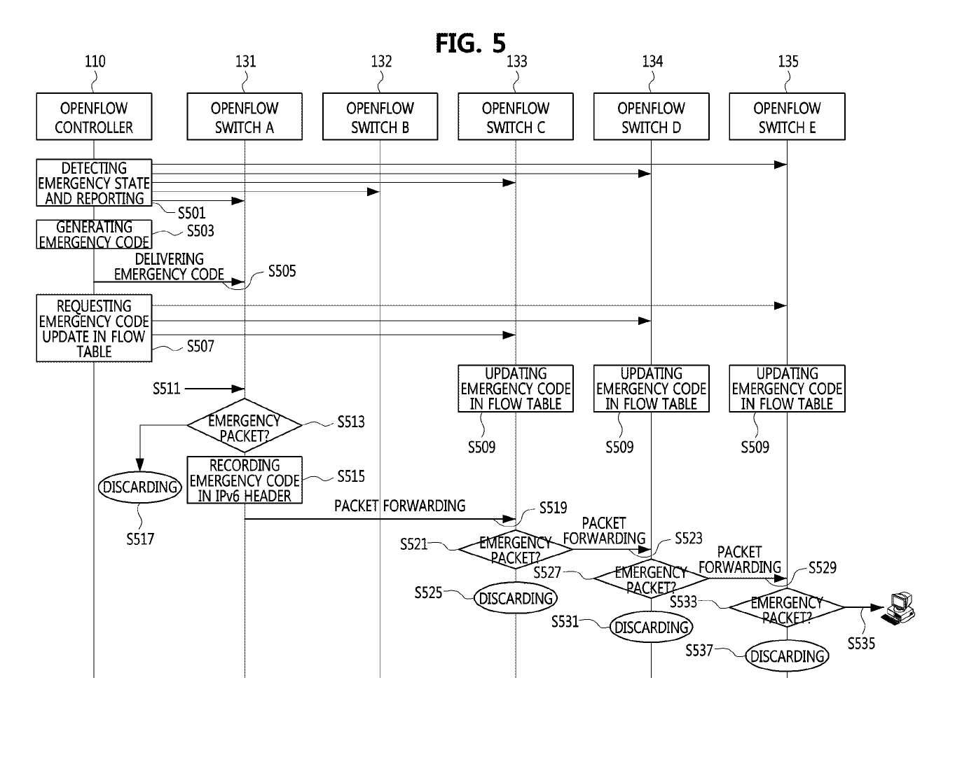

FIG. 5 is a flow chart illustrating a method for delivering emergency traffic according to an example embodiment of the present invention. As shown in FIG. 1, a method for delivering emergency traffic, in which emergency traffic is delivered through a path comprising the transmitting terminal 171, the OpenFlow switch 131, the OpenFlow switch 133, the OpenFlow switch 134, the OpenFlow switch 135, and the receiving terminal 173, is illustrated.

Referring to FIG. 5, the OpenFlow controller 110 monitors a state of the SDN network. When the emergency state is detected, the controller 110 may notify the detected emergency state to all the OpenFlow switches (S501) so that delivery of general traffic except emergency traffic is prevented. Here, the emergency traffic state information may include information about a flow in which the emergency state occurred.

Then, the OpenFlow controller 110 may generate an emergency code according to the emergency state which occurred (S503). Here, the controller 110 may configure an emergency stage class corresponding to the emergency state in the corresponding flow of the flow table of each of the OpenFlow switches 131 to 135, and generate an emergency code corresponding to the configured emergency state class.

The OpenFlow controller 110 delivers the generated emergency code to the OpenFlow switch A 131 connected to the transmitting terminal 171 (S505). Here, if the OpenFlow switch A 131 receives the emergency code transmitted from the OpenFlow controller 110, it may record the received emergency code in an emergency code field of the corresponding flow in the flow table managed by it.

Also, the OpenFlow controller 110 may transmit a message directing an update of an emergency code in each flow table of each of the OpenFlow switches constituting an emergency traffic transmission path to the OpenFlow switch 133, the OpenFlow switch 134, and the OpenFlow switch 135 (S507). Here, the OpenFlow controller 110 may transmit the emergency code as included in the message to the corresponding OpenFlow switches 133, 134, and 135. Alternatively, the controller may transmit the emergency state class information to the corresponding OpenFlow switches 133, 134, and 135 instead of transmitting the emergency code. If the OpenFlow controller 110 transmits the emergency state class information, the OpenFlow switches which receive the emergency state class information may generate the emergency code according to the received emergency state class information, and record the generated emergency code in the corresponding field of the flow table. Or, the OpenFlow controller 110 may transmit only information directing an update of emergency code to the OpenFlow switches. Accordingly, the corresponding OpenFlow switches may generate an emergency code and record the generated emergency code in the corresponding flow of the flow table.

The OpenFlow switch 133, the OpenFlow switch 134, and the OpenFlow switch 135, which constitute the emergency traffic transmission path, may update an emergency code by recording the emergency code in the emergency code field of the flow table according to the emergency code update message received from the OpenFlow controller 110 (S509).

As described above, in the state that a configuration for delivering emergency traffic is completed, when the OpenFlow switch 131 receives a packet transmitted from the transmitting terminal 171 (S511), the OpenFlow switch 131 may check whether the received packet is a packet corresponding to an emergency flow by comparing information recorded in a header of the received packet and information about emergency flows recorded in the flow table (S513).

If the OpenFlow switch 131 determines that a packet received from the transmitting terminal 171 is a packet corresponding to an emergency flow, the OpenFlow switch 131 may record an emergency code in the corresponding field of an IPv6 header of the received packet (S515), and then deliver the packet in which the emergency code is recorded to a next OpenFlow switch (that is, the OpenFlow switch 133) by referring to emergency flow information of the flow table (S519). Here, as shown in FIG. 4, the OpenFlow switch 131 may record the emergency code in the emergency code field of the extension header of the IPv6 header of the received packet, and record information indicating that the emergency code is recorded in the extension header in the next header field.

Or, if the OpenFlow switch 131 determines that a packet received from the transmitting terminal 171 is not a packet corresponding to an emergency flow, the OpenFlow controller 131 may discard the received packet (S517).

The OpenFlow switch 133 may check whether the received packet is a packet corresponding to an emergency flow by comparing information recorded in a header of the received packet with information about emergency flows recorded in the flow table (S521). Here, the OpenFlow switch 133 may determine whether the received packet is a packet corresponding to an emergency flow or not by comparing information such as a transmitting terminal address, a receiving terminal address, and emergency code information included in a header of the received packet with information about emergency flows recorded in the flow table.

If the OpenFlow switch 133 determines that the received packet corresponds to an emergency flow, the OpenFlow switch 133 may deliver the received packet to a next OpenFlow switch (that is, the OpenFlow switch 134) by referring to the flow table (S523). On the contrary, if the OpenFlow switch 133 determines that the received packet does not correspond to an emergency flow, the OpenFlow switch 133 may discard the received packet (S525).

The OpenFlow switch 134 may check whether the received packet is a packet corresponding to an emergency flow by comparing information recorded in a header of the received packet with information about emergency flows recorded in the flow table (S527). Here, the OpenFlow switch 134 may determine whether the received packet is a packet corresponding to an emergency flow or not by comparing information such as a transmitting terminal address, a receiving terminal address, and emergency code information included in a header of the received packet with information about emergency flows recorded in the flow table.

If the OpenFlow switch 134 determines that the received packet corresponds to an emergency flow, the OpenFlow switch 134 may deliver the received packet to a next OpenFlow switch (that is, the OpenFlow switch E) by referring to the flow table (S529).

On the contrary, if the OpenFlow switch 134 determines that the received packet does not correspond to an emergency flow, the OpenFlow switch 134 may discard the received packet (S531).

The OpenFlow switch 135 may receive a packet transmitted from the OpenFlow switch 134, and check whether the received packet is a packet corresponding to an emergency flow by comparing information recorded in a header of the received packet with information about emergency flows recorded in the flow table (S533). Here, the OpenFlow switch 135 may determine whether the received packet is a packet corresponding to an emergency flow or not by comparing information such as a transmitting terminal address, a receiving terminal address, and emergency code information included in a header of the received packet with information about emergency flows recorded in the flow table.

If the OpenFlow switch 135 determines that the received packet corresponds to an emergency flow, the OpenFlow switch 135 may deliver the received packet to the receiving terminal 173 by referring to the flow table (S535).

On the contrary, if the OpenFlow switch 135 determines that the received packet does not correspond to an emergency flow, the OpenFlow switch 135 may discard the received packet (S537).

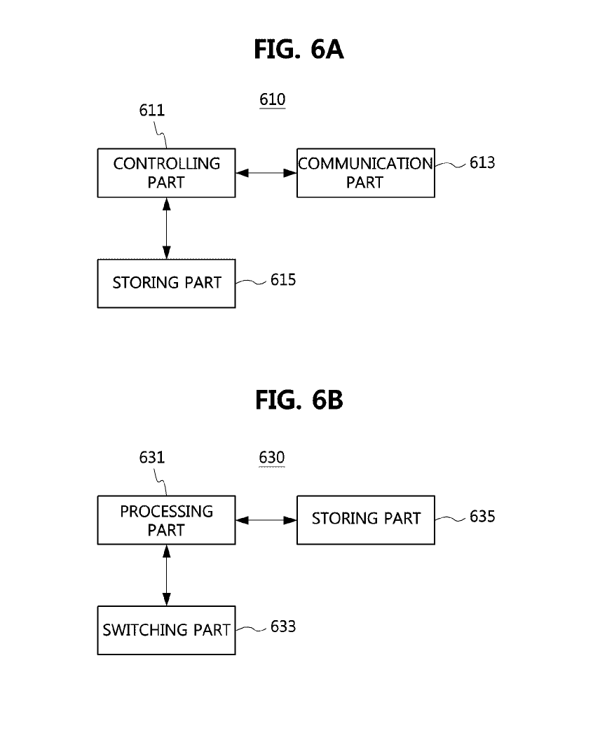

FIG. 6A is a block diagram illustrating a configuration of an OpenFlow controller performing a method for delivering emergency traffic according to an example embodiment of the present invention, and FIG. 6B is a block diagram illustrating a configuration of an OpenFlow switch performing a method for delivering emergency traffic according to an example embodiment of the present invention.

Referring to FIG. 6A, an OpenFlow controller 610 according to an example embodiment of the present invention may comprise a controlling part 611, a communication part 613, and a storing part 615.

The controlling part 611 may make flow tables for each of the OpenFlow switches connected to the controller 610, configure a packet transmission path on the SDN network from a transmitting terminal to a receiving terminal, and deliver information about the configured transmission path to the OpenFlow switches located in the transmission path through the communication part 613.

Also, the controlling part 611 monitors whether an emergency state occurs or not, and performs control for transferring emergency traffic (or, emergency packets) when the emergency state occurs.

Specifically, the controlling part 611 monitors a state of the SND network, detects emergency states, and delivers emergency state information to all the OpenFlow switches through the communication part 613 when the emergency state is detected. Here, the controlling part 611 may configure emergency state class corresponding to the emergency state which occurred in the flow table of each OpenFlow switch.

Also, the controlling part 611 may generate an emergency code according to the emergency state which occurred, transmit the generated emergency code to an OpenFlow switch connected to the transmitting terminal through the communication part 613, and transmit a message directing an update of the emergency code to a plurality of OpenFlow switches constituting the emergency traffic transmission path through the communication part 613.

The communication part 613 may be configured with various communication interfaces for transmitting and receiving signals, and perform communications with a plurality of OpenFlow switches according to control of the controlling part 611.

The storing part 615 may be configured with a non-volatile memory, and flow tables for the OpenFlow switches 630, made by the controlling part 611, may be stored in the storing part 615.

On the other hand, referring to FIG. 6B, an OpenFlow switch 630 according to an example embodiment of the present invention may comprise a processing part 631, a switching part 633, and a storing part 635.

The processing part 631 may configure flow tables based on information provided from the OpenFlow controller 610, and store the configured flow tables in the storing part 635.

Also, the processing part 631 may discriminate packets received from a transmitting node or other OpenFlow switches according to flows, and process the received packets according to rules defined in the flow table.

When the processing part 631 receives an emergency code from the OpenFlow controller 610, if the received packet corresponds to an emergency flow, the processing part 631 may record the emergency code in an IPv6 extension header of the received packet, and deliver the packet in which the emergency code is recorded to another OpenFlow switch as defined in the flow table. On the contrary, if the received packet does not correspond to an emergency flow, the processing part 631 may discard the received packet. For the above described procedure, the processing part 631 may determine whether the received packet corresponds to an emergency flow or not by comparing information included in the header of the received packet with information about emergency flows of the flow table.

Or, when the processing part 631 receives a message directing an update of an emergency code from the OpenFlow controller 610, the processing part 631 may update the emergency code of the corresponding flow according to the message. Then, if the received packet corresponds to an emergency flow, the processing part 631 may perform forwarding of the packet as defined in the emergency flow. On the contrary, if the received packet does not correspond to an emergency flow, the processing part 631 may discard the received packet.

The switching part 633 may include a communication mean and a switching mean, perform communications with the OpenFlow controller 110, and perform a function of delivering the received packet to a specific port or a function of discarding the received packet according to control of the controlling part 631. Here, the switching part 633 may be configured as a single physical entity comprising the communication mean and the switching mean. Or, the communication mean and the switching mean may be configured as independent entities.

The storing part 635 may be configured with a non-volatile memory, and a flow table managed by the processing part 631 may be stored in the storing part 635.

In the above described software defined network, according to a method for transferring emergency traffic and an apparatus performing the same, an OpenFlow controller may generate an emergency code when an emergency state occurs, provide the generated emergency code to OpenFlow switches connected to a transmitting terminal, and request an update of emergency code to other OpenFlow switches. The OpenFlow switch connected to the transmitting terminal may record the received emergency code in an IPv6 header of a packet corresponding to an emergency flow, and deliver the packet to other OpenFlow switches. When other OpenFlow switches receive the request of emergency code update from the OpenFlow controller, they may update the emergency code for the corresponding flow of the flow table managed by them, determine whether the received packet is a packet corresponding to an emergency flow or not based on the updated flow table, and deliver or discard the received packet based on a result of the determination.

Therefore, when an emergency state occurs in a network, emergency traffic corresponding to the emergency state may be delivered efficiently, and stabilities of network management and service qualities may be guaranteed accordingly.

While the example embodiments of the present invention and their advantages have been described in detail, it should be understood that various changes, substitutions and alterations may be made herein without departing from the scope of the invention.

What is claimed is:

1. A method for delivering emergency traffic, performed in a controller, the method comprising:
generating an emergency code for delivering the emergency traffic when an emergency state corresponding to a predefined type occurs;
transmitting the emergency code to a first OpenFlow switch connected to a transmitting terminal transmitting the emergency traffic; and
transmitting a message directing an update of the emergency code to at least one OpenFlow switch included in a forwarding path of the emergency traffic.

2. The method of claim 1, further comprising transmitting information indicating that the emergency state occurred to the at least one OpenFlow switch included in the forwarding path of the emergency traffic when the emergency state occurred.

3. The method of claim 2, wherein the information includes information about a flow in which the emergency state occurred.

4. The method of claim 1, wherein the generating an emergency code for delivering the emergency traffic includes configuring an emergency state class corresponding to the emergency state which occurred in a flow table of each of the at least one OpenFlow switch included in the forwarding path of the emergency traffic.

5. The method of claim 4, wherein the flow table includes an emergency state class field in which the emergency state class is recorded.

6. The method of claim 1, wherein, in the transmitting a message directing an update of the emergency code, the message includes information about the emergency code.

7. A method for delivering emergency traffic, performed in an OpenFlow switch, the method comprising:
receiving an emergency code from an OpenFlow controller;
checking whether a packet received from a transmitting terminal is a packet corresponding to an emergency flow or not; and
when the received packet is a packet corresponding to an emergency flow, recording the emergency code in a header of the received packet and transmitting the received packet.

8. The method of claim 7, further comprising receiving information indicating that an emergency state occurred from the controller prior to the receiving an emergency code.

9. The method of claim 7, wherein the receiving an emergency code includes recording the received emergency code in an emergency code field of a flow table.

10. The method of claim 9, wherein the checking whether a packet received from a transmitting terminal is a packet corresponding to an emergency flow or not is performed by checking whether information included in the header of the received packet with flow information, in which emergency codes are recorded, of the flow table.

11. The method of claim 7, wherein, in the recording the emergency code in a header of the received packet and transmitting the received packet, the emergency code is recorded in an emergency code field in an extension header region of the header of the received packet, and the received packet is transmitted when the received packet corresponds to an emergency flow, and the received packet is discarded when the received packet does not correspond to an emergency flow.

12. An OpenFlow controller comprising:
a controlling part configured to generate an emergency code for delivering emergency traffic when an emergency state corresponding to a predefined type occurs, transmit the generated emergency code to a first OpenFlow switch connected to a transmitting terminal, and transmit a message directing an update of the emergency code to at least one OpenFlow switch included in a forwarding path of the emergency traffic; and
a communication part communicating with the first OpenFlow switch and the at least one OpenFlow switch according to control of the controlling part.

13. The apparatus of claim 12, wherein the controlling part transmits information indicating that the emergency state occurred to the first OpenFlow switch and the at least one OpenFlow switch when the emergency state occurred.

14. The apparatus of claim 13, wherein the controlling part transmits information about a flow in which the emergency state occurred as included in the information indicating that the emergency state occurred when the emergency state occurred.

15. The apparatus of claim 12, further comprising a storing part storing data, wherein the controlling part records an emergency state class corresponding to the emergency state which occurred in an emergency state class field of a flow table of each of the first OpenFlow switch and the at least one OpenFlow switch, and stores the flow table in the storing part.
